(19) United States
(12) Patent Application Publication
(10) Pub. No.: US 2013/0283696 A1
(43) Pub. Date: Oct. 31, 2013

(54) CASEMENT WINDOW FALL PREVENTION DEVICE WITH AN EMERGENCY ESCAPE RELEASE MECHANISM

(71) Applicant: She Shun Zhang, Shanghai (CN)

(72) Inventor: She Shun Zhang, Shanghai (CN)

(21) Appl. No.: 13/457,653

(22) Filed: Apr. 27, 2012

(51) Int. Cl. E05D 13/00

(52) U.S. Cl. CPC E05D 13/006
USPC 49/322

(57) ABSTRACT

A casement window opening control fall prevention device having an emergency escape release mechanism. The device includes a limit arm of selected length having a pivotal connection at a proximal end secured to the casement window frame and a roller at its distal end received and confined for travel in a track secured to the casement window sash. An outer limit stop is provided in the track and positioned to stop the roller at an outer sash opening limit position in the track to thereby prevent a child from falling through the window opening. An escape disengagement opening is provided in the track for escape through the window opening in an emergency. This escape disengagement opening is positioned outwardly in the track beyond the outer limit stop and is dimensioned to pass the roller to thereby disengage the roller from the track by forcing the roller beyond the outer limit stop and through the opening with hand manipulation of the limit arm.

### FIELD OF THE INVENTION

The present invention pertains to window opening control devices, and more particularly to a casement window fall prevention device with an emergency escape release mechanism.

### BACKGROUND OF THE INVENTION

ASTM International, formerly known as the American Society for Testing and Materials, is a globally recognized organization in the development and delivery of international voluntary consensus standards, in part, pertaining to consumer safety specifications addressing window fall prevention devices that protect against potential falls by children age five years and under through open windows. Window opening control devices restrict the size of the open area of the window so that it is too small for a young child to fall through. They do this by allowing the window opening to be set at a predetermined position. In addition, such window fall prevention devices must be provided with an emergency escape release mechanism in the case of fire or other emergencies.

Currently in the market, there are a limited number of devices to control the opening angle of a casement window. These devices have limit arms of fixed length which prevent the window from opening beyond a predetermined limit. It is an object of the present invention to provide a device which permits a casement window to open further beyond the limit by applying two independent actions as required by ASTM. The device of the present invention provides the consumer with the flexibility to open the window to four inches to avoid having anything fall through the window, and at the same time, the device of the present invention is also able to disengage from the window sash and allow the casement window to open further for emergency escape.

### SUMMARY OF THE INVENTION

The casement window fall prevention device of the present invention is provided with an emergency escape release mechanism. The casement window fall prevention device includes a limit arm of selected length having a pivotal connection at its proximal end for securement to a casement window frame and a roller at its distal end received and confined for travel in a track which is securable to a casement window sash. An outer limit stop is provided in the track and is positioned to stop the roller at an outer sash opening limit position, which normally might permit the window to open only to approximately four inches to prevent anything from falling out of the window.

An escape disengagement opening is provided in the track and is positioned outwardly beyond this outer limit stop and is dimensioned to pass the roller for thereby disengaging the roller from the track by forcing the roller beyond the outer limit stop and then through the disengagement opening with hand manipulation of the limit arm. This outer limit stop is comprised of a narrowed neck area in the track which is dimensioned to pass the roller with a forced fit. In addition, a disengagement stop is preferably positioned in the track at the outer most extend of the disengagement opening for engagement by the roller to align the roller with the opening for disengagement.

The track also includes a side roller access passage located at an inner most sash closed position. This side roller access passage faces the limit arm for permitting passage of the roller from outside of the track for re-engagement with the track when the sash is closed. A rest stop is provided and positioned on and secured to the window frame for engaging the limit arm and thereby positioning the roller in alignment for passage through this access passage when the sash is fully closed. This access passage includes a flexibly displaceable side restriction that is dimensioned to permit passage of the roller through the access passage with forced engagement and displacement by the roller. The roller cannot then exit through the access passage.

In summary the present invention provides the following:
1. The device of the present invention allows consumers to open the casement window four inches at a first stage.
2. This device will allow casement windows to open further by disconnecting the limit arm from the window sash, whereupon the detached limit arm can be pivoted inward to rest in a resting base which is installed on the window frame. The limit arm is detached by two independent actions—a forced push outward through the outer limit stop and then a push downward to pass the roller through the disengagement opening.
3. The device will automatically reset to its initial position by simply closing the window.

### BRIEF DESCRIPTION OF THE DRAWINGS

Other objects and advantages appear hereinafter in the following description and claims. The appended drawings show for the purposes of exemplification, without limiting the scope of the invention or the appended claims, certain practical embodiments of the present invention wherein:

FIG. 1 is a perspective bottom view of the casement window track for the casement window opening control device of the present invention;

FIG. 2 is a perspective top view of the limit arm for the casement window opening control device of the present invention for use in combination with the track illustrated in FIG. 1 and shown in further combination with a resting base for the casement window limit arm;

FIG. 3 is a perspective view of the casement window opening control device of the present invention illustrating the limit arm after being immediately disconnected from the casement window track for escape purposes;

FIG. 4 is a perspective view illustrating the casement window opening control device of the present invention in a fully closed position;

FIG. 5 is a perspective view illustrating the casement window opening control device of the present invention at a fully open position at its fall prevention opening limit position;

FIG. 6 is a perspective view of the casement window opening control device of the present invention illustrating the condition wherein the limit arm roller has been forced beyond the limit stop and is ready to be disengaged from the track for emergency escape. A portion has been cut away to reveal the internal track;

FIG. 7 is a perspective view of the casement window opening control device of the present invention as shown in FIG. 6, but illustrating the limit arm after being immediately disengaged from the track. A portion has been cut away to reveal the internal track;

FIG. 8 is a perspective view of the casement window opening control device of the present invention illustrating the limit arm being placed in its resting base ready for re-engagement to the track after escape disengagement and making ready for re-engagement of the limit arm to the track; and

FIG. 9 is a perspective view of the casement window opening control device of the present invention as illustrated in FIG. 8 wherein the track is moved with its connected sash to an almost closed position for ready re-engagement with the limit arm.

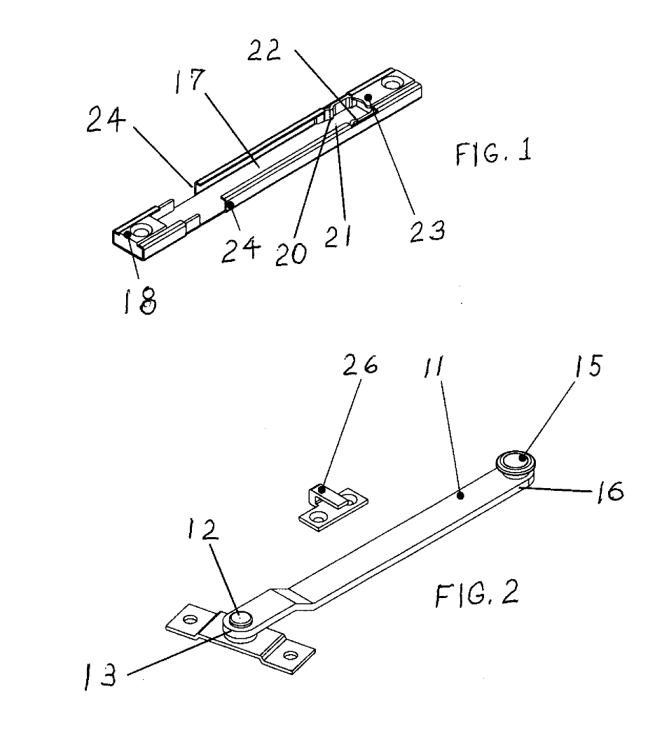

### DETAILED DESCRIPTION OF A PREFERRED EMBODIMENT

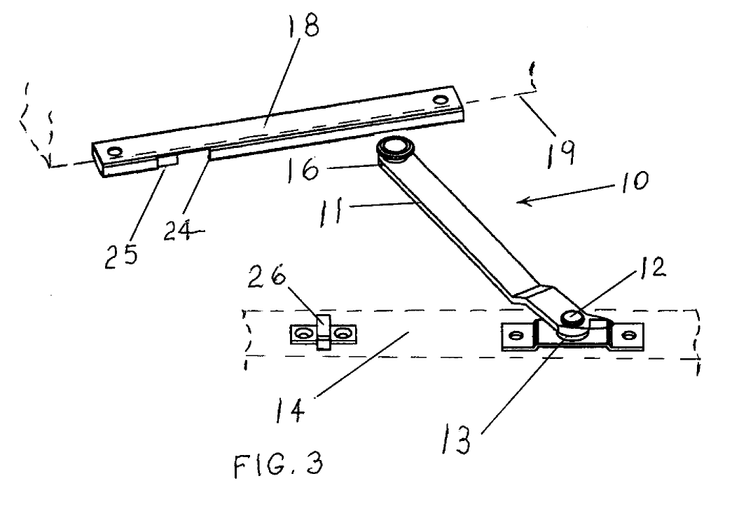

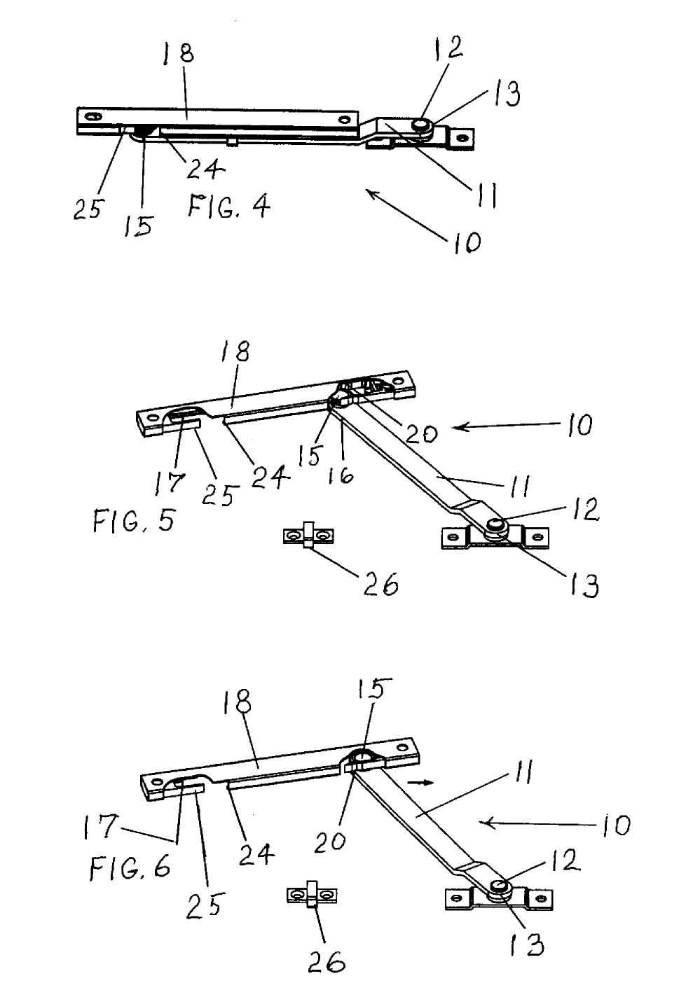

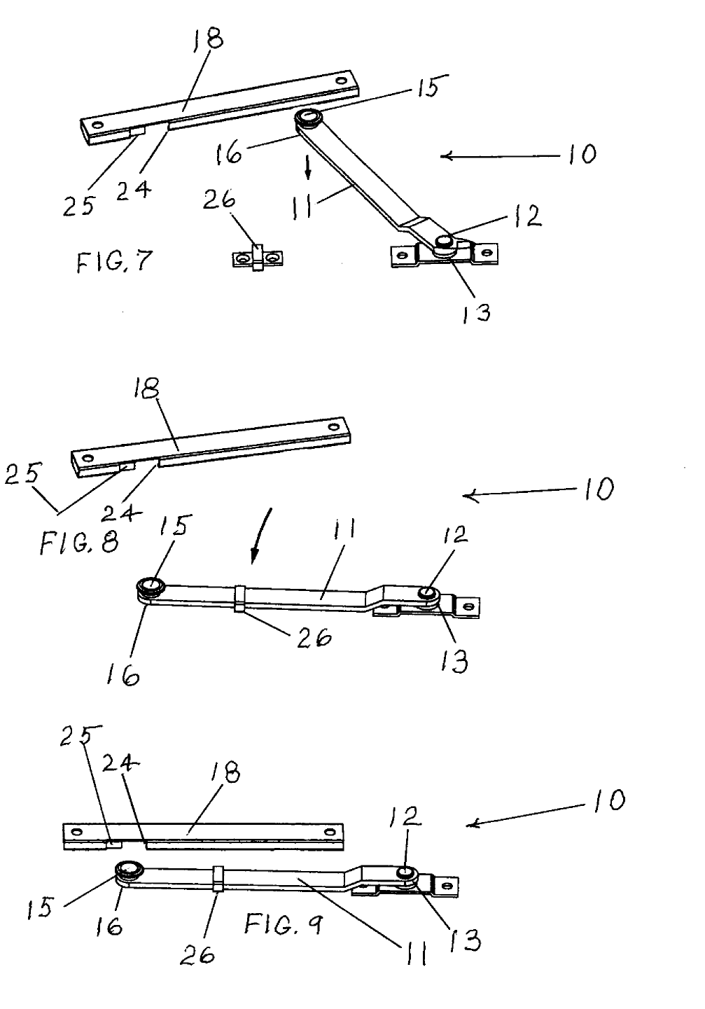

Referring to the drawings, the casement window opening control fall prevention device 10 of the present invention is a casement window opening control device incorporating an escape release mechanism according to the teachings of the present invention. In the assembly of the present invention, the limit arm 11 is of a selected length for limiting the extent of the opening of the casement window (as represented by window sash 19 in FIG. 3), and it is provided with a pivotal connection 12 at its proximal end 13 for securement to a casement window frame 14. Limit arm 11 is provided with a roller 15 provided at its distal end 16, which is normally received and confined for travel in track 17 of track arm 18 which is secured to casement window sash 19.

An outer limit stop 20 is provided in track 17 and is positioned to stop roller 15 at an outer sash opening limit position 21.

An escape disengagement opening 22 is provided in track 17 and is positioned outwardly beyond the outer limit stop 20, and is further dimensioned to pass roller 15 therethrough for thereby disengaging roller 15 from track 17 by forcing roller 15 through and beyond the outer limit stop 20 with hand force and manipulation of the limit arm 11. At this position, limit arm 11 may be pushed downwardly to thereby disengage limit arm 11 from track arm 18 whereby sash 19 may be fully opened for escape purposes.

Outer limit stop 20 provides a narrowed neck area in track 17 which is dimensioned to pass the roller 11 with a force fit. In addition, a disengagement stop 23 is provided in track 17 at the outer most extent of the disengagement opening 22 for engagement by roller 15 to align roller 15 with opening 22 for disengagement from track 17 of track arm 18.

A side roller access passage 24 is provided in track 15 and located at an innermost sash closed position. This side roller access passage 24 faces limit arm 11 for permitting passage of roller 15 from outside of track arm 18 for re-engagement within track 17 as illustrated at the stage of pre-engagement in FIG. 9 and as shown in position of total engagement in FIG. 4.

Access passage 24 is further provided with a flexibility displaceable side restriction 25 to permit passage of roller 15 through the access passage 24 with forced engagement and displacement of restriction 25 by roller 15, but thereby prevent removal of roller 15 back out of track 17 through access passage 24. A rest stop 26 is positioned on and secured to window frame 14 (FIG. 3) for engaging limit arm 11 when in a closed position for thereby positioning roller 15 in alignment for passage through access passage 24 when the sash is fully closed as illustrated in sequence in FIGS. 9 and 4.

While in the preferred embodiment illustrated, the disengagement opening 22 is positioned on a bottom side of track 17 or track arm 18, it will be further understood that this engagement opening 22 could be provided on the side of track 17 or track arm 18 whereby the disengagement opening would then be transverse to the axis of roller 15 instead of in alignment with the axis of roller 15 as shown in the described embodiment. The original embodiment illustrated is preferred because final disengagement of limit arm 11 requires a second positive manipulation action of arm 11 for escape disengagement.

In order to describe the casement window opening control device of the present invention in sequence, the window is first initially in a fully closed position as illustrated in FIG. 4. The track arm 18 and the limit arm 11 and the resting base 26 are all in the same plane and are hidden between the window sash 19 and window frame 14. When the window sash 19 starts to move outwardly or pivots outwardly, the roller 15 on limit arm 11 starts to move along track 17 until it stops at the position of limit stop 20 and there rests against the outer stop provided by the narrowed neck portion of outer limit stop 20 of the track 17.

If, as in an emergency, the window must be opened further, such as for a fire, the consumer will first manipulate the limit arm 11 by hand to force the roller 15 past the outer narrowed neck stop 20 to thereby engage the outer most stop 23 provided by a disengage block. At this point the roller 15 is properly aligned with the disengagement opening 22 and by a second action the window operator may push limit arm 11 downwardly to pass roller 15 through the disengagement opening 22 in track 17 and thereby disengage limit arm 11 from track arm 18.

For reassembly, the consumer may thereafter manually move limit arm 11 back to its resting position in base 26 so the next time the window is closed roller 15 will be re-engaged with track 17.

When the window sash 19 is being closed as shown in FIG. 9, roller 15 passes through the side opening 24 in track 17. As previously explained, side access passage 24 for roller 15 is provided with a flexibly displaceable side restriction 25 that is dimensioned to flex and permit passage of roller 15 through the access passage 24 with force engagement and displacement of the side restriction 25 by the roller 15. The setting of the assembly is thus completed and the device is ready for the next opening operation of the window opening control device 10.

1. A casement window opening control fall prevention device with an emergency escape release mechanism, the device comprising;
a rigid limit arm of pre-selected length having a pivotal connection at a proximal end for securement to a casement window frame and a roller axially secured at its distal end with said roller received and confined for travel in a track of a track arm securable to a casement window sash;
an outer limit stop in said track positioned to stop said roller at an outer sash opening limit position, said outer limit stop comprised of a narrowed neck area in said track which is dimensioned to pass said roller with a force fit; and
an escape disengagement opening in a bottom side of said track and positioned outwardly beyond said outer limit stop and dimensioned to pass said roller for thereby disengaging said roller from said track by first forcing said roller beyond said outer limit stop and then downwardly through said disengagement opening with hand manipulation of said limit arm by an operator.

2. (canceled)

3. The device of claim 1, including a disengagement stop positioned in said track beyond said outer limit stop at the outer most extent of said disengagement opening for engagement by said roller to align said roller with said disengagement opening for disengagement from said track.

4. The device of claim 1, said track further including a side roller access passage located at an inner most sash closed position and facing said limit arm for permitting passage of said roller from outside said track for re-engagement with said track.

5. The device of claim 4, further including a rest stop for positioning on and securement to the window frame for engaging and positioning said disengaged limit arm when an operator pivots said disengaged limit arm to engage said rest stop, thereby positioning said roller in alignment for passage through said access passage for re-engagement with said track when the sash is fully closed.

6. The device of claim 5, said access passage including a flexibly displaceable side restriction dimensioned to permit passage of said roller into said track through said access passage with forced engagement and displacement of said side restriction by said roller.

7. (canceled)

8. A casement window opening control fall prevention device including a rigid limit arm of pre-selected length and having a proximal end pivotally securable to the frame of a casement window, said limit arm having a roller axially secured at its distal end and received and confined in a track for travel therealong, said track securable to a sash for the casement window, an outer limit stop in said track to limit the pivotal opening extent of said sash relative to said frame by thereby limiting the travel of said roller in said track from an inner most sash closed position to an outer sash open limit position for window fall prevention;
an emergency escape release mechanism for said device comprising:
said outer limit stop further comprised of a narrowed neck area in said track dimensioned to pass said roller with a forced fit;
an escape disengagement opening in a bottom side of said track and positioned outwardly beyond said outer limit stop and dimensioned to pass said roller for thereby disengaging said roller from said track by forcing said roller beyond said limit stop and downwardly through said disengagement opening with hand manipulation of said limit arm by an operator.

9. The device of claim 8, said track further including a disengagement stop positioned in said track beyond said limit stop at the outer most extent of said disengagement opening for engagement by said roller to align said roller with said disengagement opening for disengagement.

10. (canceled)

11. The device of claim 8, said track further including a side roller access passage located at an inner most sash closed position and facing said limit arm for permitting passage of said roller from outside said track for re-engagement with said track.

12. The device of claim 11, including a rest stop positioned on and secured to the window frame for engaging and positioning said disengaged limit arm when an operator pivots said disengaged limit arm to engage said rest stop, thereby positioning said roller in alignment for passage through said access passage into said track when the sash is fully closed.

13. The device of claim 12, said access passage further including a flexibly displaceable side restriction dimensioned to flex and thereby permit passage of said roller with forced engagement and displacement of said side restriction by said roller.

14. (canceled)

15. A casement window opening limit track securable to a window sash and configured and dimensioned to receive and confine a window limit arm roller therein carried by a rigid limit arm whereby the roller travels in said track when said limit arm moves from an inner sash closed position to an outer limit stop at an outer sash open limit position, the improvement including:
said outer limit stop comprised of a narrowed neck area in said track dimensioned to pass said roller with a forced fit;
an escape disengagement opening in a bottom side of said track and positioned outwardly beyond said outer limit stop and dimensioned to pass said roller for thereby disengaging said roller from said track by forcing said roller beyond said outer limit stop and downwardly through said disengagement opening with hand manipulation of said limit arm by an operator.

16. The track of claim 15, including a disengagement stop positioned in said track at the outer most extent of said disengagement opening for engagement by said roller to align said roller with said opening for disengagement from said track, said disengagement opening positioned in alignment with the axis of said roller.

17. (canceled)

18. The track of claim 15, said track further including a side roller access passage located at an inner most sash closed position and facing said limit arm for permitting passage of said roller therethrough from outside said track for re-engagement with said track.

19. The track of claim 18, including a rest stop for positioning on and securement to the window frame for engaging and positioning said disengaged limit arm when an operator pivots said disengaged limit arm to engage said rest stop, thereby positioning said roller in alignment for passage through said access passage when the sash is fully closed.

20. The track of claim 19, said access passage further including a flexibly displaceable side restriction dimensioned to permit passage of said roller through said access passage with forced engagement and displacement of said side restriction by said roller.
